(19) United States
(12) Patent Application Publication
(10) Pub. No.: US 2026/0235783 A1
(43) Pub. Date: Aug. 13, 2026

(54) METHOD AND SYSTEM FOR DETECTING A WEATHER CONDITION OF A LOCATION

(71) Applicant: GRABTAXI HOLDINGS PTE. LTD., Singapore (SG)

(72) Inventors: Igor STEBLII, Singapore (SG); Philipp KANDAL, Singapore (SG)

(73) Assignee: GRABTAXI HOLDINGS PTE. LTD., Singapore (SG)

(21) Appl. No.: 19/471,461

(22) PCT Filed: Feb. 8, 2024
(86) PCT No.: PCT/SG2024/050069

§ 371 Date: Oct. 1, 2025

(30) Foreign Application Priority Data
Apr. 1, 2023 (SG) 10202300901S

(51) Int. Cl. G01W 1/00

(52) U.S. Cl. CPC G01W 1/00

(57) ABSTRACT

The present disclosure provides methods and systems for detecting a weather condition of a location. In some examples, there is provided a method comprising: determining, by a processor, whether an audio recording of the location from a user device at the location corresponds to the weather condition, the determination being based on historical data indicating at least one corresponding sound for the weather condition; and detecting, by the processor, the weather condition of the location based on the determination.

### FIELD OF INVENTION

The present disclosure relates broadly, but not exclusively, to methods and systems for detecting a weather condition of a location.

### BACKGROUND

Accurate weather forecasts, including rain, hail, snow and flooded road detection are important for ride-hailing and delivery platforms because they help to ensure efficient and safe operations. By having access to up-to-date information on weather conditions and road conditions, it is possible to plan routes that avoid areas likely to be impacted by bad weather, such as flooded roads. This helps to reduce the risk of accidents, delays, and cancellations, which in turn improves customer satisfaction and reduces costs. In addition, the ability to detect and respond to changes in weather conditions in real-time can help to minimize the impact of unexpected weather events, allowing these companies to continue to operate effectively even in challenging conditions. Ultimately, accurate weather and road condition information is essential for ensuring the safety and efficiency of ride-hailing and delivery services, and is critical to their success.

Conventionally, weather conditions are measured by meteorological instruments, weather satellites, weather balloons, ground-based radar, weather observations, computer models, and other similar instruments. Many of these methods can be applied to detect road conditions, such as based on observation or usage of satellite imagery. However, industry methods tend to be costly and only provide broad, slow and general results instead of hyper local results (e.g., results having a precision of up to street level status). As such, the results of weather detection may be incorrect, especially in the Southeast Asia (SEA) region where weather conditions can change within hours due to, for example, monsoons, tropical climate, Intertropical Convergence Zone (ITCZ) proximity to the equator, and other similar factors.

For example, some industry methods predict weather by using data from a variety of open sources, including meteorological satellites, radar, and weather stations. Some may run unconventional meteorology models to predict weather. Despite using innovative approaches, they still rely on open data. In some cases, they do not provide services outside of certain regions (e.g., outside of the USA) due to lack of data.

Further, other industry methods may use a combination of meteorological data from weather stations and meteorological organizations, as well as remote sensing data from satellites and other sources to detect weather. They may also use machine learning algorithms to process this data and generate weather forecasts. However, such weather prediction providers tend to be costly and complicated to set up.

Neither of the existing solutions provide hyper local, high confidence results, at various environments, at scale. To achieve a hyperlocal, realtime weather detection, it is necessary to deploy weather stations across all cities, which is not scalable. Observation by trained personnel might provide high accuracy results but it is not scalable, as 24/7 surveillance and a lot of manual labor are required.

A need therefore exists to provide methods and systems that seek to overcome or at least minimize the above mentioned challenges.

### SUMMARY

According to a first aspect of the present disclosure, there is provided a method for detecting a weather condition of a location, the method comprising: determining, by a processor, whether an audio recording of the location from a user device at the location corresponds to the weather condition, the determination being based on historical data indicating at least one corresponding sound for the weather condition; and detecting, by the processor, the weather condition of the location based on the determination.

According to a second aspect of the present disclosure, there is provided a system for detecting a weather condition of a location, comprising: at least one processor; and at least one memory including computer program code; the at least one memory and the computer program code configured to, with the at least one processor, cause the system at least to: determine whether an audio recording of the location from a user device at the location corresponds to the weather condition, the determination being based on historical data indicating at least one corresponding sound for the weather condition; and detect the weather condition of the location based on the determination.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 illustrates a system for detecting a weather condition of a location according to various embodiments of the present disclosure.

FIG. 2 is a schematic diagram of a weather server, according to various embodiments of the present disclosure.

FIG. 3A depicts a flow diagram for detecting a weather condition of a location according to various embodiments of the present disclosure.

FIG. 3B depicts an illustration of rain intensity determination and verification according to various embodiments of the present disclosure.

FIG. 3C depicts an illustration of hyper local weather detection according to various embodiments of the present disclosure.

FIG. 3D depicts another illustration of hyper local weather detection according to various embodiments of the present disclosure.

FIG. 4A depicts a flowchart for detecting a weather condition of a location according to various embodiments of the present disclosure.

FIG. 4B depicts an illustration of how a determination of a weather condition is verified by one or more other user devices according to various embodiments of the present disclosure.

FIG. 5A depicts an illustration of a request for verification of a weather condition according to various embodiments of the present disclosure.

FIG. 5B depicts an illustration of a request for verification of a weather condition during a trip booking according to various embodiments of the present disclosure.

FIG. 6 depicts an illustration of how a model for processing an audio recording may be adjusted according to various embodiments of the present disclosure.

FIG. 7 illustrates an example flow diagram for detecting a weather condition of a location according to various embodiments.

FIG. 8A is a schematic block diagram of a general purpose computer system upon which the weather server of FIG. 2 can be practiced.

FIG. 8B is a schematic block diagram of a general purpose computer system upon which a combined transaction processing and weather server of FIG. 1 can be practiced.

FIG. 9 shows an example of a computing device to realize the transaction processing server shown in FIG. 1.

FIG. 10 shows an example of a computing device to realize the weather server shown in FIG. 1.

FIG. 11 shows an example of a computing device to realize a combined transaction processing and weather server shown in FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

### Terms Description

A platform refers to a set of technologies that is used as a base for facilitating exchanges between two or more interdependent servers, entities and/or devices, for example between a requestor device (e.g., associated with a requestor of a product or service) and a provider device (e.g., associated with a provider of the product or service). For example, a platform may offer a service offered by a provider such as a ride, delivery, online shopping, insurance, and other similar services to a requestor. A requestor can typically access the platform via a website, an application, or other similar methods using the requestor device. The provider device may be associated with a driver who may provide a ride or delivery that is requested (e.g., a trip booking) by a requestor. In the present disclosure, the requestor device and the provider device may be referred to herein as a user device, wherein a user associated with the user device may be a requestor or a provider.

A location is one at which a user device may be located. The location may be provided in the form of Global Positioning System (GPS) information, latitudinal and longitudinal coordinates, geohash information, and other similar information.

A weather condition (e.g., rain, wind, thunder, hail, flood, snow, and other similar weather condition and intensity thereof) may be determined for the location based on an audio recording that may be recorded at the location by the user device (e.g., an audio recording comprising any sound, background noise, etc that may be recorded of the location by the user device at the location). For example, a machine learning (ML) model may be utilized (e.g., processing “on the edge” by the user device, or centralized processing via a dedicated server, or other similar configurations) to process the audio recording (e.g., processing each of one or more segments of the audio recording in real time as it is being recorded, or after a time delay, or other similar configurations depending on application) to determine whether the audio recording corresponds to a weather condition. The determination may be based on historical data indicating at least one corresponding sound for a weather condition. For example, if an audio recording of a location is determined to comprise a sound that, based on the historical data, corresponds to a light rain, then it may be detected that there is light rain at the location. The historical data may indicate a variety of sounds or sound patterns that correspond to various weather conditions, for example rain ambient sounds (falling rain drops), sounds of rain falling on a surface such as a car windscreen, asphalt, a water surface (e.g., rain falling onto a puddle), a sheltered area (e.g., rain falling on a tinned roof, window, or other similar sound) or a device such as a handphone, or sounds corresponding to a vehicle passing a flooded or unflooded street, distinctive sounds such as thunder or wind of varying intensity, and other similar sounds. Processing “on the edge” by the user device may present several advantages. For example, in order to send an audio recording from the user device to a server, consent is typically required from the user (e.g., from a driver providing a ride service and, in some instances, as well as from the passenger of the ride service if the driver is in transit). This is not necessary if processing is on the edge. It is also possible to prevent a potential leak of private data if such sending of audio recordings to a server is avoided. Further, ML is a costly and time consuming process, and on top of that audio data has a big footprint. Sending such data to a server (e.g., via a mobile data connection) for ML processing is likely to consume large amounts of user data and server time. Thus, it is advantageously possible to cut cost and time of processing by implementing ML processing of the audio recording “on the edge” by the user device.

In at least some embodiments, a user may be any suitable type of entity, which may include a person, a consumer looking to purchase a product or service via a transaction processing server, a seller or merchant looking to sell a product or service via the transaction processing server, a motorcycle driver or pillion rider in a case of the user looking to book or provide a motorcycle ride via the transaction processing server, a car driver or passenger in a case of the user looking to book or provide a car ride via the transaction processing server, and other similar entity. A user who is registered to the transaction processing server will be called a registered user. A user who is not registered to the transaction processing server will be called a non-registered user. The term user will be used to collectively refer to both registered and non-registered users. A user may interchangeably be referred to as a requestor (e.g., a person who requests for a product or service) or a provider (e.g., a person who provides the requested product or service to the requestor).

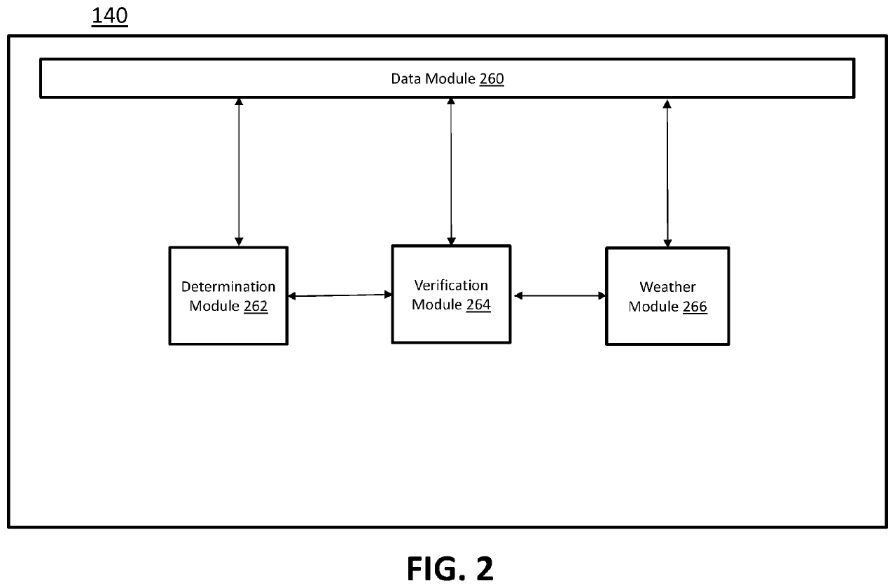

In at least some embodiments, a weather server is a server that hosts software application programs for detecting a weather condition of a location. The weather server may be implemented as shown in schematic diagram 200 of FIG. 2 for detecting a weather condition of a location.

In at least some embodiments, a transaction processing server is a server that hosts software application programs for processing payment transactions for, for example, a request for a driver, a travel-coordination request, purchasing of a good or service by a user, and other similar services. The transaction processing server communicates with any other servers (e.g., a weather server) concerning processing payment transactions relating to the purchasing of the good or service, such as a request for a driver (which may be referred to interchangeably as a trip booking, or a request or booking for a ride, delivery, or other similar service that requires a driver). For example, data relating to a request message such as a request for a driver (e.g., date, time, a location, and other similar data) may be provided to the weather server and processed to locate drivers that are in proximity to the location, detect a weather condition of the location, and other similar services. The transaction processing server may use a variety of different protocols and procedures in order to process the payment and/or driver requests.

Transactions that may be performed via a transaction processing server include product or service purchases, credit purchases, debit transactions, fund transfers, account withdrawals, etc. Transaction processing servers may be configured to process transactions via cash-substitutes, which may include payment cards, letters of credit, checks, payment accounts, etc.

In at least some embodiments, the transaction processing server is usually managed by a service provider that may be an entity (e.g., a company or organization) which operates to process transaction requests and/or driver requests e.g., pair a driver to a requestor of the driver request. The transaction processing server may include one or more computing devices that are used for processing transaction requests and/or driver requests.

In at least some embodiments, a transaction account is an account of a user who is registered at a transaction processing server. The user can be a customer, a merchant providing a product for sale on a platform and/or for onboarding the platform, a ride or delivery provider (e.g., a driver), or any third parties (e.g., a courier) who want to use the transaction processing server. In certain circumstances, the transaction account is not required to use the transaction processing server. A transaction account includes details (e.g., name, address, vehicle, face image, etc.) of a user. The transaction processing server manages the transaction.

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “identifying”, “detecting”, “grouping”, “determining”, “associating”, “selecting”, “calculating”, “processing”, “storing”, “indicating”, “clustering”, “partitioning”, “dividing”, or the like, refer to the action and processes of a computer system, or similar electronic device, that manipulates and transforms data represented as physical quantities within the computer system into other data similarly represented as physical quantities within the computer system or other information storage, transmission or display devices.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the specification.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

In the present disclosure, a scalable, efficient and hyperlocal approach for weather detection is proposed using audio recording combined with multiple verification methods. Leveraging on a user device (e.g., phone, camera, dash camera, etc.) and ML model (e.g., for on the edge or centralised processing), it is possible to sample audio recordings in real time that are recorded by a microphone of the user device and detect weather conditions based on sound wave patterns that are recorded. To improve confidence that a determined weather condition is accurate, a comprehensive verification flow may be utilized by combining verification from the user device and from one or more users nearby based on, for example, an automatic server driven verification triggered by a determination of a weather condition from the user device. It is further possible to take into account a user profile associated with the user device (e.g., a vehicle type, an activity type, and other similar information), as well as a current status, a current location, and other similar information associated with the user device to select a ML model specifically trained for a situation based on the user profile and combined information to effectively filter out noise from the audio recording. Advantageously, a high accuracy of weather condition detection at a location may be achieved by sampling audio recordings from one or more user devices at or around the location and seeking user verification for the detected weather condition.

The distance from which one can hear a weather condition (e.g., rain, hail, snow, flood, thunder, wind, or other weather conditions) can vary based on various factors such as the intensity of the precipitation, wind speed and direction, and ambient noise level. For example, rain and hail can typically be heard from a few hundred meters to a kilometer away, and thunder can often be heard from several kilometers away, sometimes even further under ideal conditions. Due to the distinctive sound pattern, rain can be detected with a high confidence even with a short audio recording. A variety of sounds or sound patterns that correspond to various weather conditions may be utilized for comparison with an audio recording for determining a weather condition, for example rain ambient sounds (falling rain drops), sounds of rain falling on a surface such as a car windscreen, asphalt, a water surface (e.g., rain falling onto a puddle), a sheltered area (e.g., rain falling on a tinned roof, window, or other similar sound) or a device such as a handphone, or sounds corresponding to a vehicle passing a flooded or unflooded street, distinctive sounds such as thunder or wind of varying intensity, and other similar sounds.

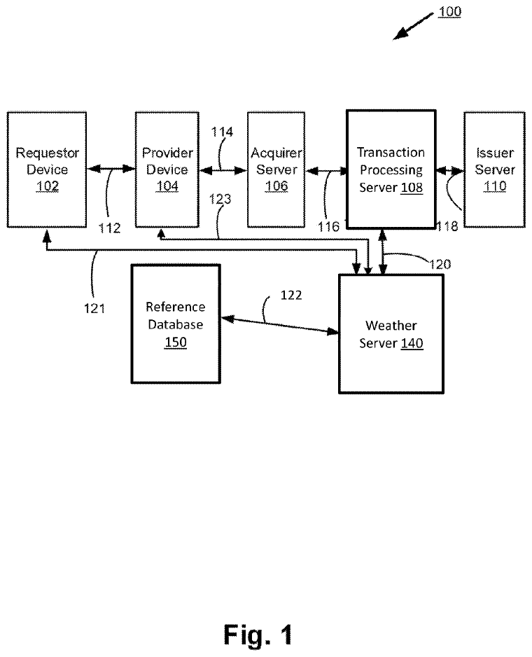

FIG. 1 illustrates a block diagram of an example system 100 for detecting a weather condition of a location. In some embodiments, the system 100 enables a payment transaction for a good or service, and/or a request for a driver e.g., for a ride or delivery of a physical item (e.g. one or more food items or a parcel) between a requestor and a provider.

The system 100 comprises a requestor device 102, a provider device 104, an acquirer server 106, a transaction processing server 108, an issuer server 110, a weather server 140 and a reference database 150.

The requestor device 102 is in communication with a provider device 104 via a connection 112, and may be associated with a user. The connection 112 may be wireless (e.g., via NFC communication, Bluetooth, etc.) or over a network (e.g., the Internet). The requestor device 102 is also in communication with the weather server 140 via a connection 121, wherein the weather server 140 may be configured to receive information relating to a request for a driver (e.g., information such as a location at which a driver is required, information identifying the user and/or requestor device 102 sending the request, and other similar information) from the requestor device 102. The requestor device 102 may also be configured to provide information to the weather server 140 relating to a location (e.g., GPS information, latitudinal and longitudinal coordinates, geohash information, or other similar information) at which the requestor device 102 is located, as well as information relating to detecting a weather condition of the location, for example an audio recording of the location (e.g., recorded by, for example, a microphone of the requestor device 102 at the location), a result of a determination of a weather condition based on the audio recording, a result of a verification request to verify whether the determined weather condition is accurate or correct, and other similar information. The connection 121 may be via a network (e.g., the Internet). The requestor device 102 may also be connected to a cloud that facilitates the system 100 for detecting a weather condition of a location. For example, the requestor device 102 can send a signal or data to the cloud directly via a wireless connection (e.g., via NFC communication, Bluetooth, etc.) or over a network (e.g., the Internet). It will be appreciated that there can be a plurality of requestor devices 102 such that each requestor device 102 is associated with a respective user.

The provider device 104 is in communication with the requestor device 102 as described above, usually via the transaction processing server 108, and may be associated with a provider of a ride or delivery (e.g., a driver responding to a request for, for example, a trip booking). The provider device 104 is, in turn, in communication with an acquirer server 106 via a connection 114. The provider device 104 is also in communication with the weather server 140 via a connection 123, wherein the weather server 140 may be configured to receive information relating to a location (e.g., GPS information, latitudinal and longitudinal coordinates, geohash information, or other similar information) at which the provider device 104 is located, a status of the driver (e.g., available, unavailable, driving for a trip booking, or other similar statuses), identification information relating to the requestor device 102 (e.g., associated with a trip booking that the provider device 104 is handling) and/or provider device 104, and other similar information from the provider device 104. The connections 114 and 123 may be via a network (e.g., the Internet). The provider device 104 may also be connected to a cloud that facilitates the system 100 for detecting a weather condition of the location. For example, the provider device 104 can send a signal or data to the cloud directly via a wireless connection (e.g., via NFC communication, Bluetooth, etc.) or over a network (e.g., the Internet). It will be appreciated that there can be a plurality of provider devices 104 such that each provider device 104 is associated with a respective user.

The acquirer server 106, in turn, is in communication with the transaction processing server 108 via a connection 116. The transaction processing server 108, in turn, is in communication with an issuer server 110 via a connection 118. The connections 116 and 118 may be via a network (e.g., the Internet).

The transaction processing server 108 is further in communication with the weather server 140 via a connection 120. The connection 120 may be over a network (e.g., a local area network, a wide area network, the Internet, etc.). In one arrangement, the transaction processing server 108 and the weather server 140 are combined and the connection 120 may be an interconnected bus.

The weather server 140, in turn, is in communication with the reference database 150 via respective connection 122. The connection 122 may be over a network (e.g., the Internet). The weather server 140 may also be connected to a cloud that facilitates the system 100 for detecting a weather condition of the location. For example, the weather server 140 can send a signal or data to the cloud directly via a wireless connection (e.g., via NFC communication, Bluetooth, etc.) or over a network (e.g., the Internet).

The reference database 150 may comprise data that is utilized by the weather server 140 for detecting a weather condition of a location. For example, data relating to at least one corresponding sound for each of one or more weather conditions, a user profile and other information associated with a user device (e.g., if not received directly from the user device or from the transaction processing server 108), information relating to a location at which a user device is located (e.g., an activity and sound(s) associated with the location, for example due to ongoing construction works at the location), data relating to a ML model or algorithm that may be used to process an audio recording for detecting a weather condition, and other information and/or data required for detecting a weather condition of a location may be processed and stored in the reference database 150. In an implementation, the reference database 150 may be combined with the weather server 140. In an example, the reference database 150 may be managed by an external entity.

The weather server 140 may be configured to determine whether an audio recording of a location from a user device at the location corresponds to a weather condition, the determination being based on historical data indicating at least one corresponding sound for the weather condition. The weather server 140 may also detect the weather condition of the location based on the determination.

In an implementation, there may be more than one reference databases, in which the weather server 140 may be configured to determine which database to use for each step during the process of detecting a weather condition of a location. Alternatively, one or more modules may store the above-mentioned data instead of the reference database 150, wherein the module may be integrated as part of the weather server 140 or external from the weather server 140.

In the illustrative embodiment, each of the devices 102, 104, and the servers 106, 108, 110, 140, and/or reference database 150 provides an interface to enable communication with other connected devices 102, 104 and/or servers 106, 108, 110, 140, and/or reference database 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for the requestor device 102 to send data relating to a request for a driver such as a location at which the driver is required, and for the provider device 104 to send data relating to a location or a status of an associated driver, in response to an enquiry shown on the GUI running on the respective API.

Use of the term ‘server’ herein can mean a single computing device or a plurality of interconnected computing devices which operate together to perform a particular function. That is, the server may be contained within a single hardware unit or be distributed among several or many different hardware units.

The weather server 140 is associated with an entity (e.g., a company or organization or moderator of the service). In one arrangement, the weather server 140 is owned and operated by the entity operating the transaction processing server 108. In such an arrangement, the weather server 140 may be implemented as a part (e.g., a computer program module, a computing device, etc.) of the transaction processing server 108.

The transaction processing server 108 may also be configured to manage the registration of users. A registered user has a transaction account (see the discussion above) which includes details of the user. The registration step is called on-boarding. A user may use either the requestor device 102 or the provider device 104 to perform on-boarding to the transaction processing server 108.

It may not be necessary to have a transaction account at the transaction processing server 108 to access the functionalities of the transaction processing server 108. However, there are functions that are available to a registered user. These additional functions will be discussed below.

The on-boarding process for a user is performed by the user through one of the requestor device 102 or the provider device 104. In one arrangement, the user downloads an app (which includes the API to interact with the transaction processing server 108) to the requestor device 102 or the provider device 104. In another arrangement, the user accesses a website (which includes the API to interact with the transaction processing server 108) on the requestor device 102 or the provider device 104. The user is then able to interact with the weather server 140. The user may be a requestor or a provider associated with the requestor device 102 or the provider device 104, respectively.

Details of the registration may include, for example, name of the user, address of the user, emergency contact, blood type or other healthcare information, next-of-kin contact, permissions to retrieve data and information from the requestor device 102 and/or the provider device 104 for detecting a weather condition of a location, such as permission to retrieve location and status information, and/or retrieve an audio recording, and/or send push notifications including a request for verification whether a detected weather condition is correct, and other similar data and information from the requestor device 102 and/or the provider device 104. Alternatively, another device (e.g., a mobile device, a dash camera, and other similar device) may be selected instead of the requestor device 102 and/or the provider device 104 for retrieving the data. Once on-boarded, the user would have a transaction account that stores all the details.

The requestor device 102 is associated with a user (or requestor) who is a party to a transaction that occurs between the requestor device 102 and the provider device 104, or between the requestor device 102 and the weather server 140. The requestor device 102 may be a computing device such as a desktop computer, an interactive voice response (IVR) system, a smartphone, a laptop computer, a personal digital assistant computer (PDA), a mobile computer, a tablet computer, and the like. The requestor device 102 may be associated with a user who initiates a request for a trip booking.

The requestor device 102 includes transaction credentials (e.g., a payment account) of a requestor to enable the requestor device 102 to be a party to a payment transaction. If the requestor has a transaction account, the transaction account may also be included (e.g., stored) in the requestor device 102. For example, a mobile device (which is a requestor device 102) may have the transaction account of the customer stored in the mobile device.

In one example arrangement, the requestor device 102 is a computing device in a watch or similar wearable and is fitted with a wireless communications interface (e.g., a NFC interface). The requestor device 102 can then electronically communicate with the provider device 104 regarding a transaction request (e.g., for a trip booking). The user uses the watch or similar wearable to make request regarding the transaction request by pressing a button on the watch or wearable.

The provider device 104 is associated with a provider who is also a party to the transaction request (e.g., for a trip booking) that occurs between the requestor device 102 and the provider device 104. The provider device 104 may be a computing device such as a desktop computer, an interactive voice response (IVR) system, a smartphone, a laptop computer, a personal digital assistant computer (PDA), a mobile computer, a tablet computer, and the like. The provider device 104 may be associated with a provider of a ride or delivery (e.g., a driver responding to the trip booking request).

Hereinafter, the term “provider” refers to a service provider and any third party associated with providing a product or service for purchase, or a travel or ride or delivery service via the provider device 104. Therefore, the transaction account of a provider refers to both the transaction account of a provider and the transaction account of a third party (e.g., a driver, travel co-ordinator or merchant) associated with the provider.

If the provider has a transaction account, the transaction account may also be included (e.g., stored) in the provider device 104. For example, a mobile device (which is a provider device 104) may have the transaction account of the provider stored in the mobile device.

In one example arrangement, the provider device 104 is a computing device in a watch or similar wearable and is fitted with a wireless communications interface (e.g., a NFC interface). The provider device 104 can then electronically communicate with the requestor to make request regarding the transaction request by pressing a button on the watch or wearable.

The acquirer server 106 is associated with an acquirer who may be an entity (e.g., a company or organization) which issues (e.g., establishes, manages, administers) a payment account (e.g., a financial bank account) of a merchant. Examples of the acquirer include a bank and/or other financial institution. As discussed above, the acquirer server 106 may include one or more computing devices that are used to establish communication with another server (e.g., the transaction processing server 108) by exchanging messages with and/or passing information to the other server. The acquirer server 106 forwards the payment transaction relating to a transaction request or a request for a ride to the transaction processing server 108.

The transaction processing server 108 is configured to process processes relating to a transaction by, for example, forwarding data and information associated with the transaction to the other servers in the system 100 such as the weather server 140. In an example, the transaction processing server 108 may, instead of the requestor device 102 or provider device 104, transmit data relating to a request message such as a request for a trip booking (e.g., date, time, a location, and other similar data) to the weather server 104. The transaction processing server 108 may use a variety of different protocols and procedures in order to process the payment and/or trip booking requests. It will be appreciated that payment for a transaction may be made via a variety of methods such as credit cards, debit cards, digital wallets, buy-first pay-later schemes, and other similar payment methods.

The issuer server 110 is associated with an issuer and may include one or more computing devices that are used to perform a payment transaction. The issuer may be an entity (e.g., a company or organization) which issues (e.g., establishes, manages, administers) a transaction credential or a payment account (e.g., a financial bank account) associated with the owner of the requestor device 102. As discussed above, the issuer server 110 may include one or more computing devices that are used to establish communication with another server (e.g., the transaction processing server 108) by exchanging messages with and/or passing information to the other server.

The reference database 150 is a database or server associated with an entity (e.g., a company or organization) which manages (e.g., establishes, administers) data relating to users, transactions, products, services, and other similar data, for example relating to the entity. In an arrangement, the reference database 150 may comprise data that is utilized by the weather server 140 for detecting a weather condition of a location. For example, data relating to at least one corresponding sound for each of one or more weather conditions, a user profile and other information associated with a user device (e.g., if not received directly from the user device or from the transaction processing server 108), information relating to a location at which a user device is located (e.g., an activity and sound(s) associated with the location, for example due to ongoing construction works at the location), data relating to a ML model or algorithm that may be used to process an audio recording for detecting a weather condition, and other information and/or data required for detecting a weather condition of a location may be processed and stored in the reference database 150. In an implementation, the reference database 150 may be combined with the weather server 140. In an example, the reference database 150 may be managed by an external entity.

Advantageously, the system 100 enables a high accuracy of weather condition detection at a location by sampling audio recordings from one or more user devices at or around the location and seeking user verification for the detected weather condition.

FIG. 2 illustrates a schematic diagram of an example weather server 140 according to various embodiments. The weather server 140 may comprise a data module 260 configured to receive data and information from the requestor device 102, provider device 104, transaction processing server 108, reference database 150, a cloud and other sources of information to detect a weather condition of a location by the weather server 140. For example, the data module 260 may be configured to receive data and information required for determining whether an audio recording of a location corresponds to a weather condition and detecting the weather condition of the location based on the determination, determining whether a user associated with a user device is driving, identifying one or more other user devices within a proximity from a user device, confirming a weather condition based on one or more verifications, determining an area around a location with a determined weather condition, filtering noise from an audio recording, determining whether a location is sheltered, and other similar processes from the requestor device 102, the provider device 104, transaction processing server 108, reference database 150, and/or other sources of information. The data module 260 may be further configured to send information relating to data retrieved in response to a trip booking request to the requestor device 102, the provider device 104, the transaction processing server 108, or other destinations where the information is required.

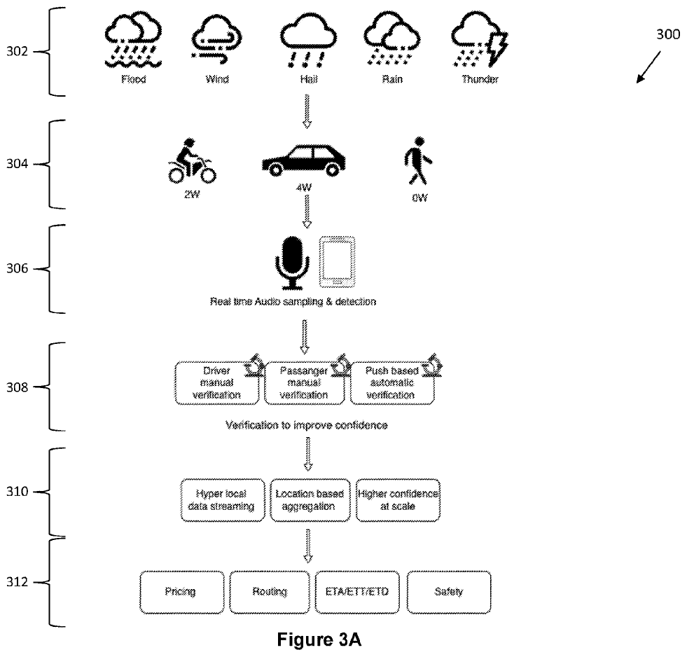

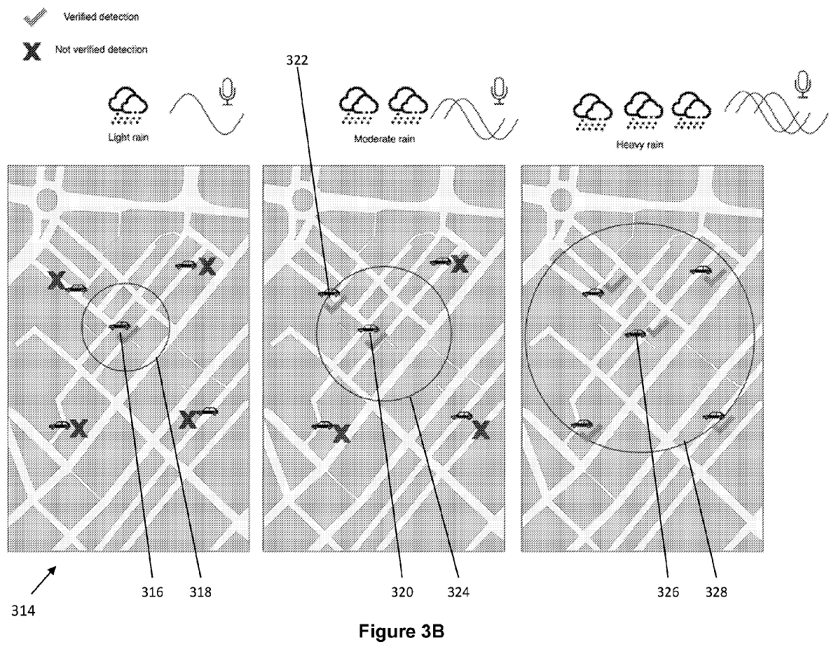

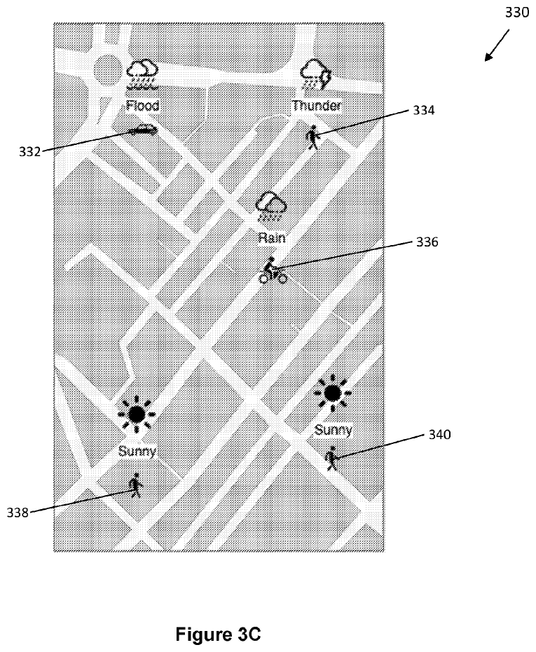

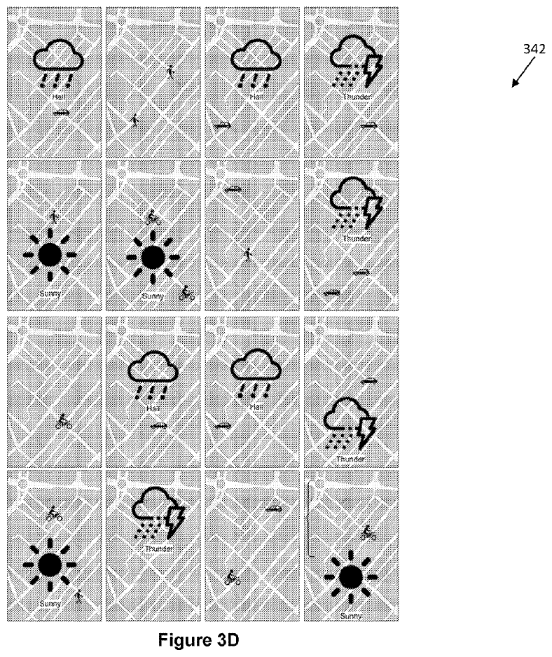

The weather server 140 may comprise a determination module 262 that is configured for determining whether an audio recording of a location from a user device at the location corresponds to the weather condition, the determination being based on historical data indicating at least one corresponding sound for the weather condition. In an implementation, the determination module 262 may be configured to determine, for each of one or more segments of the audio recording, whether each segment corresponds to the weather condition based on the historical data, the determination being made in real time as the user device is recording each segment at the location; filter a determination result for each of the one or more segments based on a threshold; and determine the weather condition of the location based on the filtered determination result. In an implementation, the determination module 262 may be configured to further determine whether an audio recording from each of one or more other user devices corresponds to a weather condition. In an implementation, the determination by the determination module 262 may further comprise filtering noise from the audio recording based on the location as well as a vehicle and an activity associated with the user device, the filtering being based on the historical data further indicating at least one sound associated with each of the location, the vehicle and the activity. In an implementation, the determination module 262 may be configured to determine whether the audio recording corresponds to an indication that the location is sheltered, the determination being based on the historical data further indicating at least one sound associated with a sheltered area. The determination process is further explained in FIGS. 3A-3D, 4A-4B and 6.

The weather server 140 may also comprise a verification module 264 that is configured for requesting a verification from the user device whether a determined weather condition for the location is correct. In an implementation, the verification module 264 may be further configured to determine whether a user associated with the user device is driving, the determination based on a trip booking associated with the user, and request a verification from another user device whether a determined weather condition for the location is correct, the another user device being a requestor of the trip booking. In an implementation, the verification module 264 may be further configured to, in response to a verification from the user device, identify one or more other user devices within a proximity from the user device, and request a further verification from each of the one or more other user devices whether a further determined weather condition for each of the one or more other user devices is correct. The verification process is further explained in FIGS. 3A-3D, 4A-4B and 5A-5B.

The weather server 140 may also comprise a weather module 266 that is configured for detecting the weather condition of the location based on the determination (e.g., by the determination module 262). In an implementation, the weather module 266 may be configured to confirm the weather condition of the location based on a verification from the user device or another user device, the another user device being a requestor of a trip booking associated with the user device. In an implementation, the weather module 266 may be configured to further confirm the weather condition of the location based on a further verification from each of one or more other user devices. In an implementation, the weather module 266 may be further configured to determine an area around the location with the determined weather condition based on the verification from the user device and the further verification from the one or more other user devices. In an implementation, the weather module 266 may be further configured to determine an intensity of the determined weather condition based on the verification and the further verification. In an implementation, the weather module 266 may be further configured to recommend a route to the user based on the determination whether the audio recording corresponds to the indication that the location is sheltered. In an implementation, the weather module 266 may be further configured to aggregate data relating to a plurality of previous detections of weather conditions of the location, and detect the weather condition of the location further based on the aggregated data. The weather detection process is further explained in FIGS. 3A-3D, 4A-4B and 5A-5B.

Each of the data module 260, determination module 262, verification module 264 and weather module 266 may further be in communication with a processing module (not shown) of the weather server 140, for example for coordination of respective tasks and functions during the process. The data module 260 may be further configured to communicate with and store data and information for each of the processing module, determination module 262, verification module 264 and weather module 266. Alternatively, all the tasks and functions required for adaptively detecting a weather condition of a location may be performed by a single processor of the weather server 140.

FIG. 3A depicts a flow diagram 300 for detecting a weather condition of a location according to various embodiments of the present disclosure. At step 302, a weather condition (e.g., flood, wind, hail, rain, thunder, and other weather conditions) may be occurring at a location. At step 304, a user (e.g., associated with a user device) may be at the location with the weather condition. The user may be riding a two-wheeled vehicle (e.g., a bicycle, motorcycle, or other similar vehicle), a four-wheeled vehicle (e.g., a car, a van, a pick-up, or other similar vehicle), or other type of vehicles that may be indicated in, for example, a user profile associated with the user, a trip booking associated with the user, or other similar manner. The user may also simply be on foot instead of using a vehicle. At step 306, the user device may be utilized to perform audio sampling of the location (e.g., record an audio recording of the location) in real time. In an implementation, detection of a weather condition based on the audio recording may be performed in real time via, for example, a ML model installed on the user device, or performed via central processing from a server (e.g., by the weather server 140).

At step 308, a request for verification may be sent to the user device to confirm that a weather condition that is determined from the audio sampling is correct. In an implementation, if it is determined that the user is driving for a trip booking associated with the user, the request for verification may be sent instead to another user e.g., a passenger associated with the trip booking. In an implementation, one or more other user devices who are within proximity from the user device (e.g., one or more other user devices near the location at which the user device is located) may be identified. A push notification to perform audio sampling (e.g., record an audio recording of a location at which each of the one or more other user devices are located) in real time may be sent to each of the one or more other user devices to further determine a weather condition (e.g., for each location at which each of the one or more other users are located). A further verification may further be requested from each of the one or more other user devices for verifying accuracy of each of one or more further determined weather conditions. Based on the verification (e.g., from the user device and/or, if the user is driving for a trip booking, another user device of the passenger of the trip booking) and further verification(s) from the one or more other user devices, a confidence that the determined weather condition of the location is accurate can advantageously be improved. Further, an area with the determined weather condition may also be determined based on the verification and further verification(s).

At step 310, the results of the verification and further verification(s), and/or audio recordings from the user device and the one or more other user devices may be transmitted to the weather server 140. Results of the verification and further verification(s) may be obtained at scale from a plurality of users and aggregated to advantageously provide precise and hyperlocal weather condition updates throughout the concerned area. At step 312, the obtained results of the weather conditions may be utilized for various aspects of, for example, trip and delivery bookings such as pricing (e.g., higher pricing due to detected adverse weather condition such as heavy rain, thunderstorm and/or flood at a location), routing (e.g., rerouting and recommending alternative routes in case of detected flooding of roads at a location), calculating estimated time of arrival (ETA), calculating estimated time of delivery (ETD), evaluating safety measures (e.g., for drivers in view of a detected weather condition at a location), and other similar aspects.

FIG. 3B depicts an illustration 314 of rain intensity determination and verification according to various embodiments of the present disclosure. In an example, a positive verification for a determined weather condition (e.g., light rain) may be obtained from a user device 316. In response to the verification, other user devices located within proximity from the user device 316 may be identified, and a further determination of a weather condition and a further verification may be obtained from the other user devices. If a further determined and verified weather condition from each of the other user devices are different from that obtained from the user device 316 (e.g., the further determined and verified weather condition(s) are not indicating light rain), an area 318 around the location of user device 316 but excluding the other user devices may be determined as having the determined weather condition (e.g., the area 318 is raining lightly). In another example, a positive verification for a determined weather condition (e.g., moderate rain) may be obtained from a user device 320. In response to the verification, other user devices located within proximity from the user device 320 may be identified, and a further determination of a weather condition and a further verification may be obtained from the other user devices. If only one further determined and verified weather condition obtained from the other user devices is same as that obtained from the user device 320 (e.g., only the further determined and verified weather condition from a user device 322 also indicates moderate rain), an area 324 including the location of the user device 320 and the user device 322 may be determined as having the determined weather condition (e.g., the area 324 is raining moderately). In a further example, a positive verification for a determined weather condition (e.g., heavy rain) may be obtained from a user device 326. In response to the verification, other user devices located within proximity from the user device 326 may be identified, and a further determination of a weather condition and a further verification may be obtained from the other user devices. If a further determined and verified weather condition from each of the other user devices are same as that obtained from the user device 326 (e.g., the further determined and verified weather condition(s) are also indicating heavy rain), an area 328 including locations of the user device and the other user devices may be determined as having the determined weather condition (e.g., the area 328 is raining heavily). In an implementation, upon detection of a weather condition (e.g., light rain), data collection (e.g., determination and verification of the weather condition) may be performed frequently (e.g., based on a set frequency or interval) until the event (e.g., the detected weather condition) ends, so that data relating to an intensity of the event, duration of the event, end of the event, radius of the event, changes in development of the event, and other similar attributes relating to the event may be collected and analysed.

By utilizing the proposed solution according to the present disclosure, it is possible to detect one or more different weather conditions for an area up to street level accuracy. For example, within an area as shown in illustration 330 of FIG. 3C, it may be detected that there is flooding occurring at a location at which user device 332 is located (e.g., flooding at a cross junction where a user associated with the user device 332 is driving), a thunderstorm occurring at a location at which user device 334 is located, rain occurring at where user device 336 is located, and no adverse weather condition (e.g., sunny weather) at where user devices 338 and 340 are located. Furthermore, it is possible to capture weather condition changes throughout the day for any given area, for example as shown in illustration 342 of FIG. 3D depicting different weather conditions that may be detected from various user devices at the area throughout a day. Furthermore, it is also possible to detect other conditions that may be important for determining a trip or delivery route. For example, it may be possible to detect whether a location is sheltered (e.g., if it is determined that an audio recording of a location corresponds to a sound associated with, for example, rain hitting the floor, window, roof, or other similar sounds indicative of a sheltered area), such that an optimized route with shelter can be designated for deliveries around the location especially in event of rain. To increase the confidence of a determination of a sheltered area, it is also possible to seek verification for the determination. For example, a request to verify whether an area is sheltered (e.g., a request for an answer to a question such as “Is your current area sheltered from rain?”) may be transmitted to the user device, to which an answer (e.g., “Partially”, “Yes”, No, or other suitable answer) may be provided. Such information relating to sheltered areas may be incorporated for a long term into a map for the location, and may be utilized to guide a user providing a ride or delivery service, for example via recommendation of a route along the identified sheltered areas sent to a user device belonging to the user. In an implementation, the recommendation may be based on a determination whether the user is providing a ride or delivery service on a two-wheeler, three-wheeler, four-wheeler, or other similar vehicle, or providing a delivery service on foot, since certain sheltered areas may not be accessible for certain vehicles.

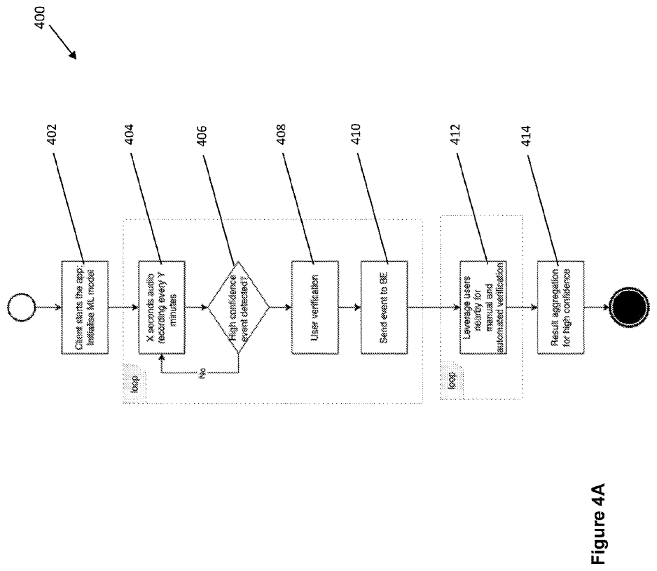

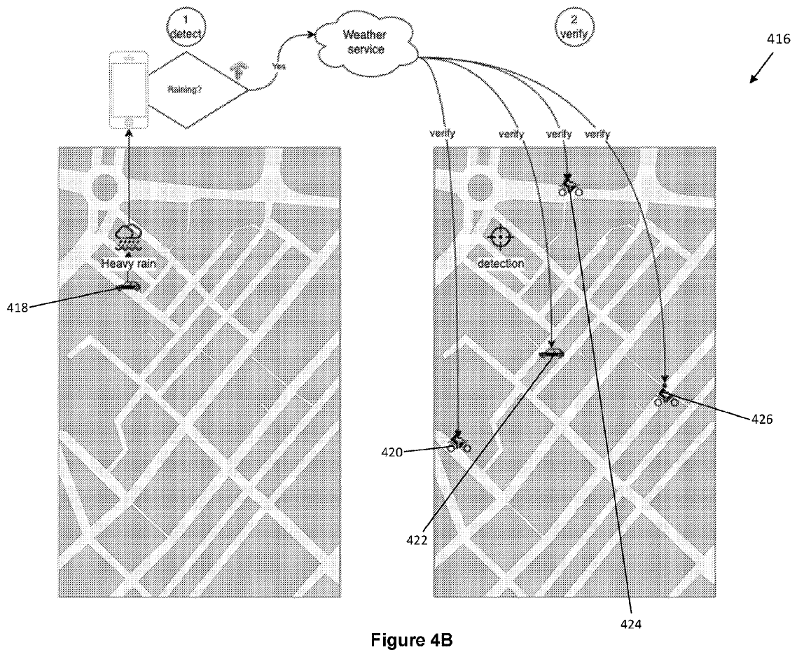

FIG. 4A depicts a flowchart 400 for detecting a weather condition of a location according to various embodiments of the present disclosure. At step 402, an application associated with the system 100 for detecting a weather condition of a location may be initiated on a user device (e.g., the requestor device 102 or provider device 104). The application may be configured to download a ML model (if not already installed on the user device) based on a user profile associated with the user device (e.g., a vehicle type, an activity type, and other similar information), as well as a current status, a current location (e.g., the location at which a weather condition is to be determined), and other similar information associated with the user device. For example, the downloaded ML model may be specifically trained for a situation based on the user profile and combined information to effectively filter out noise from an audio recording of a location that is recorded by the user device at the location. In an implementation, processing of an audio recording may be centrally performed (e.g., by a selected ML model in the weather server 140, such that data relating to the audio recording is transmitted to the weather server 140 for the determination, and the determination results transmitted back to the user device), or performed by a selected ML model that resides at another server or entity (such that data relating to the audio recording is transmitted to the ML model for the determination, and the determination results transmitted back to the user device or weather server 140) such that there may not be a need to download or install the ML model in the user device.

At step 404, the user device may be configured to record the audio recording of the location in segments of an arbitrary length at an arbitrary period, for example based on 30 seconds of audio recording in every 5 minutes. Each segment may be processed by the ML model in the user device or by the weather server 140 to determine whether the audio recording of the location from the user device at the location corresponds to a weather condition, the determination being based on historical data indicating at least one corresponding sound for the weather condition. The determination may include filtering noise from the audio recording based on the location as well as a vehicle and an activity associated with the user device, the filtering being based on the historical data further indicating at least one sound associated with each of the location, the vehicle and the activity. The determination results of each segment may be aggregated and filtered based on a threshold (e.g., a confidence threshold that may be set for the ML model based on the user profile and the combined information). At step 406, if a determination does not satisfy the threshold, the process returns to step 404 to continue audio recording of the location. Otherwise, the process proceeds to step 408 in which a verification is requested from the user device (e.g., requesting the user associated with the user device to confirm that the determined weather condition is correct). At step 410, high confidence detections of weather condition (e.g., verified by the user of the user device as accurate) may be sent to the weather server 140. In an implementation, the high confidence detections may also be sent to backend operations of a platform associated with the application or system 100, or other similar entity. It will be appreciated that steps 404 to 410 may be a loop operation.

At step 412, in response to the high confidence detections (e.g., in response to the verification from the user device), one or more other user devices that are within proximity from the user device may be identified, and a push notification may be sent to each of these one or more other user devices to start sampling and detection (e.g., start recording an audio recording of a location at which each of the other user devices are located and, based on the audio recording, further determine a corresponding weather condition by an ML model (e.g., installed on each of the one or more other user devices or another entity) or by the weather server 140), as well as request a further verification, from each of the one or more other users, for a corresponding further determined weather condition. It will be appreciated that step 412 may also be a loop operation comprising steps that are similar to steps 404 to 410, except that the determination and verification steps are performed for audio recordings that are recorded by each of the one or more other user devices. At step 414, high confidence results are aggregated based on the verification from the user device and further verification(s) from the one or more other user devices to confirm the weather condition of the location. In an implementation, an area around the location with the determined weather condition may be determined based on the verification and further verifications.

In an implementation, weather condition detections may be made automatically at an arbitrary period or moment of time, and user devices are not synchronized with each other but using relative time based on a start time of the application (e.g., the application associated with the system 100 for detecting a weather condition of a location) in each user device. Considering that some weather conditions may occur only within a very short time, it is advantageous to run detection on multiple user devices at the same time so that such short occurrences can be detected. For example, referring to illustration 416 of FIG. 4B, as soon as a weather condition (e.g., heavy rain) is detected based on an audio recording from a user device 418 at a specific location, a push notification may be transmitted to other user devices (e.g., user devices 420, 422, 424 and 426) nearby to start audio sampling and automatic weather detection. To increase the confidence of a determined weather condition, it is also possible to seek verification for the determined weather condition. For example, alternatively or in addition to sending the push notification to the user devices 420, 422, 424 and 426 nearby to start audio sampling and automatic weather detection, a request to verify whether a specific event or weather condition is occurring (e.g., a request for an answer to a question such as “Is it raining heavily?”) may be transmitted to each of these user devices. Orchestration of a wide range of user devices (e.g., leveraging on a userbase including drivers and passengers associated with a ride and delivery booking platform) can advantageously help to achieve a much higher accuracy of weather condition detection.

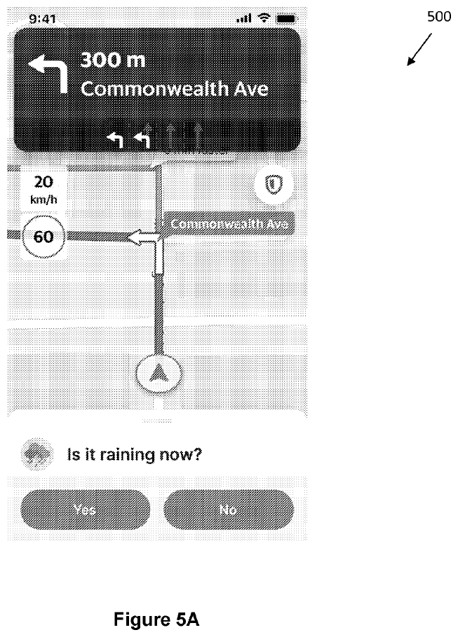

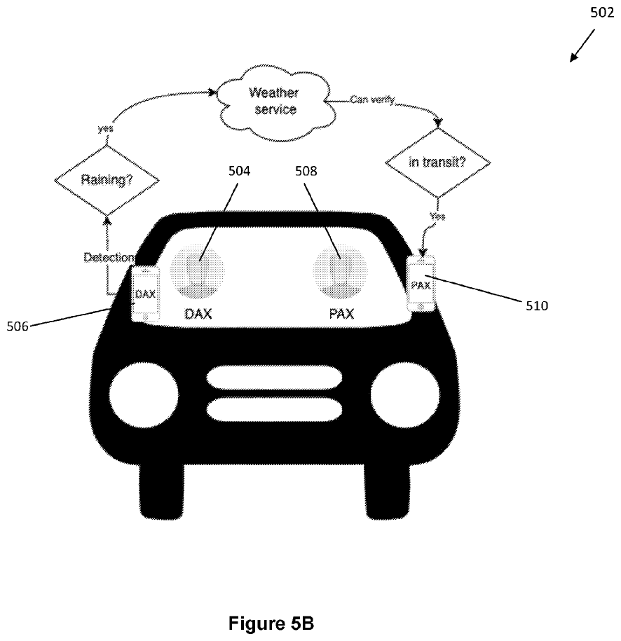

Illustration 500 of FIG. 5A depicts an exemplary verification request that may be sent to a user device after a determination of a weather condition (e.g., based on an audio recording of a location that is recorded by the user device at the location), to verify with a user associated with the user device whether the determined weather condition is correct. In illustration 500, the determined weather condition is that it is raining at the location. Thus, the user is requested to verify if the location is raining now. Based on the verification by the user (e.g., replying with a “Yes” to indicate a positive verification, or a “No” to indicate a negative verification), a further verification may then be requested from, for example, one or more other user devices that may be detected within proximity from the user device.

In an implementation, it is possible to determine an activity of a user associated with a user device and adapt a request for verification accordingly. For example, referring to illustration 502 of FIG. 5B, it may be determined that a user 504 associated with a user device 506 is driving. The determination may be based on a trip booking associated with the user device 506. For example, user 504 may accept via the user device 506 (e.g., in this case, a provider device 104) a request for a trip booking from another user device 510 (e.g., a user 508 requests via user device 510 (in this case, a requestor device 102) for a trip booking), and thus is driving the user 508 to a destination in accordance with the trip booking. A weather condition may be determined for a location by the user device 506, but since it is determined that user 504 is driving for the trip booking, a verification request is pushed to user device 510 instead (e.g., a user device associated with a passenger who requested the trip booking). Details of the trip booking (e.g., user profile associated with users 504 and 508, details of vehicle (license plate, brand, model, etc) used for trip, start location and destination of trip, start time of trip, status of trip, location of user devices 506 and 510, and other similar details) may be provided by, for example, the user device 506 (e.g., provider device 104), the user device 510 (e.g., requestor device 102) or the transaction processing server 108.

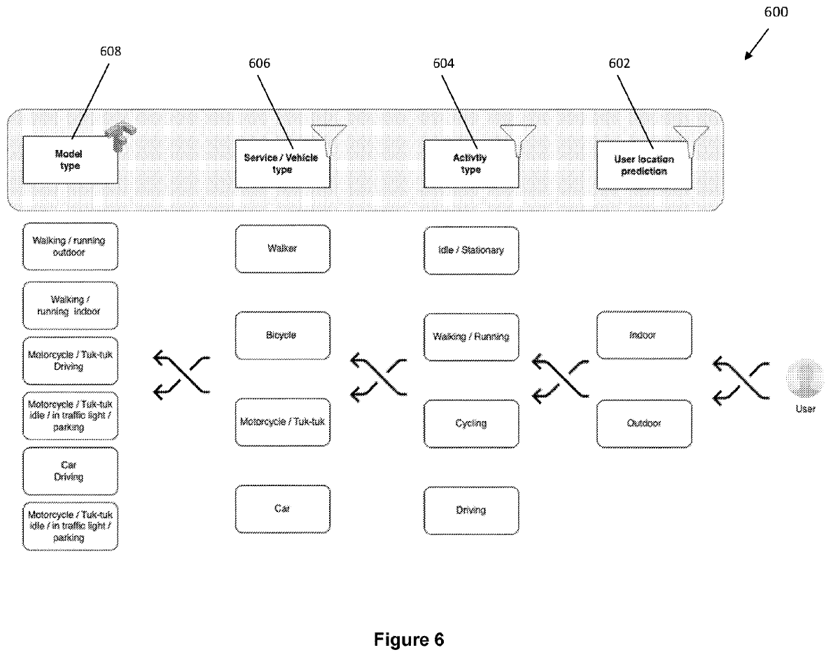

In an implementation, it is possible to leverage on a user profile associated with a user device (e.g., a vehicle type, an activity type, and other similar information), as well as a current status, a current location, and other similar information associated with the user device to reduce noise from an audio recording of a location that is recorded by the user device at the location. For example, referring to illustration 600 of FIG. 6, based on a location of a user device, a location prediction 602 may be made, for example to determine if the user device is indoors (e.g., user device is determined to be in a building, at a bus-stop, or other similar places) or outdoors. It may also be possible to determine one or more sounds that may correspond to a location based on information relating to the location. For example, it may be determined that construction works are ongoing at the location, or a traffic jam is occurring at the location, or other similar situations, such that one or more sounds corresponding to the situation may be utilized for filtering noise from the audio recording of the location.

Further, based on one or more signals (e.g., gyroscopic signals, GPS, or other similar signals) that may be retrieved from the user device, it is possible to detect a user activity type 604 (e.g., walking, cycling, running, driving, and other similar activity). A vehicle type 606 (e.g., bicycle, motorcycle, tuk-tuk, car, personal mobility device (PMD) and other similar vehicles) associated with the user device may also be determined. Such information may then be used to, for example, select a suitable ML model 608 for processing the audio recording recorded by the user device, or tweak an existing model to a suitable setting based on the information. In an implementation, noise may be filtered from the audio recording based on the location as well as a vehicle and an activity associated with the user device, in which the filtering is based on historical data that indicates at least one sound associated with each of the determined location, vehicle and activity.

Advantageously, it is possible to attain extremely high levels of accuracy from automatic determination of a weather condition based on processing of an audio recording of a location by a user device at the location (e.g., whether by a ML model installed in the user device or another entity, or the weather server 140, or other similar arrangement). The determination may be based on a continuous feedback loop to the user device (e.g., requesting a verification from the user device every time after a weather condition is determined). A further verification may also be requested from one or more other user devices that may be detected within a proximity from the user device, which can serve as a safeguard in case a user of a user device provides an incorrect verification or attempts to falsify a verification. It is further possible to use such information for future model training as well as to increase the accuracy of the weather condition determination.

In an implementation, verification of a determined weather condition may be a combination of automation (e.g., server trigger push-based detection in response to a verification provided by a user device) and manual verification from nearby users (e.g., a user associated with a detected nearby user device provides a response to a verification request, for example whether it is windy now at the location at which the nearby user device is located).

In an implementation, data relating to weather condition detections from, for example, a plurality of user devices may be aggregated in a backend of the system 100 or stored in a database (e.g., reference database 150), so that even if individual observations are incorrect, the overall quality will be high due to the sheer amount and density of observations and data available from a large number of user devices. In contrast, weather sensors such as rain sensors tend to be deployed very sparsely. For example, data relating to a plurality of previous detections of weather conditions for a location may be aggregated, and detection of a weather condition of the location may be further based on the aggregated data.

Advantageously, it is possible to discover nuanced conditions that impact drivers, for example wind-level (e.g., possibly impacting cyclists/motorcyclists), flooding on the road or other conditions that adversely impact trip bookings and deliveries. Rain intensity can also be determined, for example based on a density of detections and user verification within an area, or based on a volume and/or intensity of an audio recording, or other possible methods. Noise reduction may be implemented using models trained for detected specific environment conditions (e.g., indoor, outdoor, in-transit, etc.) to improve accuracy of weather condition determination.

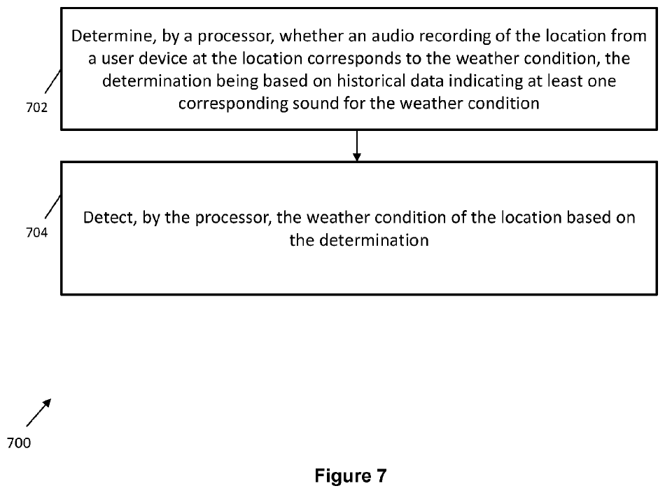

FIG. 7 illustrates an example flow diagram for a method 700 for detecting a weather condition of a location according to various embodiments. In a step 702, it is determined, by a processor, whether an audio recording of the location from a user device at the location corresponds to the weather condition, the determination being based on historical data indicating at least one corresponding sound for the weather condition. In a step 704, it is detected, by the processor, the weather condition of the location based on the determination.

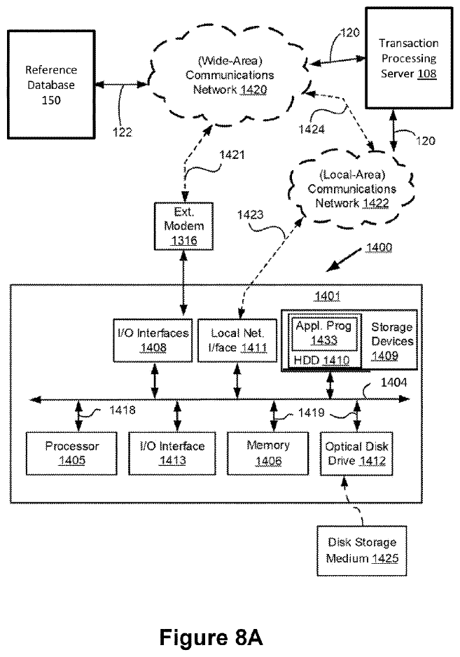

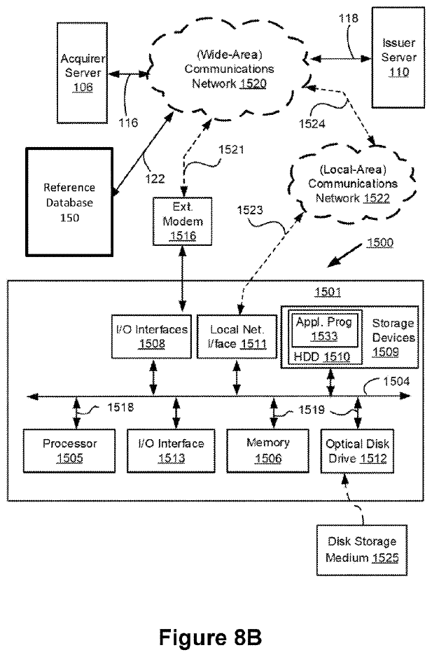

FIG. 8A depict an example computer system 1400, in accordance with which the weather server 140 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

The computer module 1401 typically includes at least one processor unit 1405, and a memory unit 1406. For example, the memory unit 1406 may have semiconductor random access memory (RAM) and semiconductor read only memory (ROM). The computer module 1401 also includes an interface 1408 for the external modem 1416. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 8A, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks, USB-RAM, portable, external hard drives, and floppy disks, for example, may be used as appropriate sources of data to the system 1400.

The components 1405 to 1412 of the computer module 1401 typically communicate via an interconnected bus 1304 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun Sparcstations, Apple or like computer systems.

The method 700, where performed by the weather server 140 may be implemented using the computer system 1400. The processes may be implemented as one or more software application programs 1433 executable within the computer system 1400. In particular, the method 700 is effected by instructions in the software 1433 that are carried out within the computer system 1400. The software instructions may be formed as one or more code modules, each for performing one or more particular tasks. The software may also be divided into two separate parts, in which a first part and the corresponding code modules performs the method 700 and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on the computer readable medium is a computer program product. The use of the computer program product in the computer system 1400 preferably effects an advantageous apparatus for a weather server 140.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for a weather server 140.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the weather server 140) is presented merely by way of example. Therefore, in some arrangements, one or more features of the computer system 1400 may be omitted. Also, in some arrangements, one or more features of the computer system 1400 may be combined together. Additionally, in some arrangements, one or more features of the computer system 1400 may be split into one or more component parts.

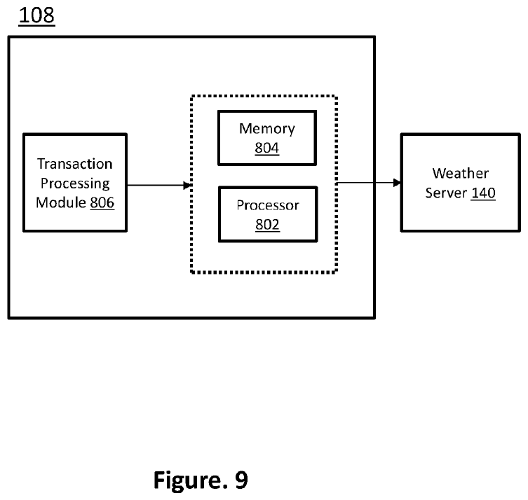

FIG. 9 shows an implementation of the transaction processing server 108 (i.e., the computer system 1300). In this implementation, the transaction processing 108 may be generally described as a physical device comprising at least one processor 802 and at least one memory 804 including computer program codes. The at least one memory 804 and the computer program codes are configured to, with the at least one processor 802, cause the transaction processing server 108 to facilitate the operations described in method 700. The transaction processing server 108 may also include a transaction processing module 806. The memory 804 stores computer program code that the processor 802 compiles to have transaction processing module 806 perform the respective functions.

With reference to FIG. 1, the transaction processing module 806 performs the function of communicating with the requestor device 102 and the provider device 104; and the acquirer server 106 and the issuer server 110 to respectively receive and transmit a transaction, a request for a driver (which may be referred to interchangeably as a trip booking, or a request or booking for a ride, delivery, or other similar service that requires a driver), or other similar messages. The transaction processing module 806 may be configured to process processes relating to a transaction by, for example, forwarding data and information associated with the transaction to the other servers in the system 100 such as the weather server 140. For example, the transaction processing server 108 may, instead of the requestor device 102 or provider device 104, transmit data relating to a request message such as a request for a driver (e.g., date, time, a location, and other similar data) to the weather server 104. The transaction processing server 108 may use a variety of different protocols and procedures in order to process the payment and/or travel co-ordination requests. It will be appreciated that payment for a transaction may be made via a variety of methods such as credit cards, debit cards, digital wallets, buy-first pay-later schemes, and other similar payment methods.

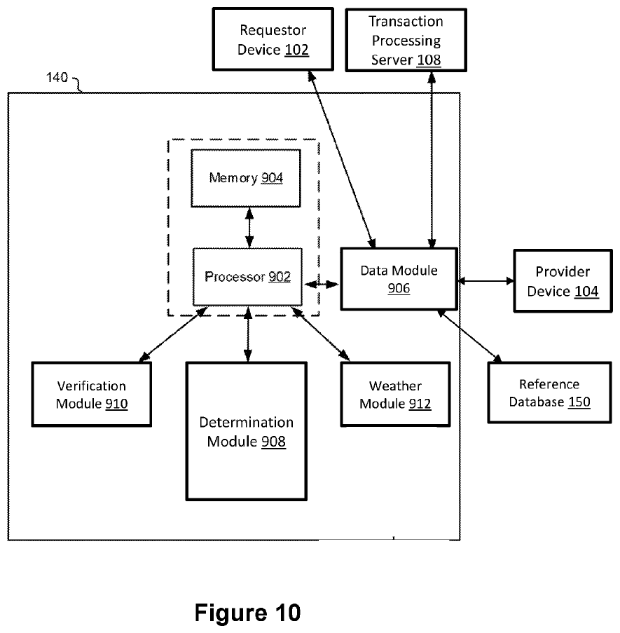

FIG. 10 shows an alternative implementation of the weather server 140 (e.g., the computer system 1400). In the alternative implementation, weather server 140 may be generally described as a physical device comprising at least one processor 902 and at least one memory 904 including computer program codes. The at least one memory 904 and the computer program codes are configured to, with the at least one processor 902, cause the weather server 140 to perform the operations described in the method 700. The weather server 140 may also include a data module 906, a determination module 908, a verification module 910 and a weather module 912. The memory 904 stores computer program code that the processor 902 compiles to have each of the modules 906 to 912 performs their respective functions.

With reference to FIGS. 1 to 7, the determination module 908 performs the function of determining whether an audio recording of a location from a user device at the location corresponds to the weather condition, the determination being based on historical data indicating at least one corresponding sound for the weather condition. In an implementation, the determination module 908 may be configured to determine, for each of one or more segments of the audio recording, whether each segment corresponds to the weather condition based on the historical data, the determination being made in real time as the user device is recording each segment at the location; filter a determination result for each of the one or more segments based on a threshold; and determine the weather condition of the location based on the filtered determination result. In an implementation, the determination module 908 may be configured to further determine whether an audio recording from each of one or more other user devices corresponds to a weather condition. In an implementation, the determination by the determination module 908 may further comprise filtering noise from the audio recording based on the location as well as a vehicle and an activity associated with the user device, the filtering being based on the historical data further indicating at least one sound associated with each of the location, the vehicle and the activity. In an implementation, the determination module 908 may be configured to determine whether the audio recording corresponds to an indication that the location is sheltered, the determination being based on the historical data further indicating at least one sound associated with a sheltered area.

With reference to FIGS. 1 to 7, the verification module 910 performs the function of requesting a verification from the user device whether a determined weather condition for the location is correct. In an implementation, the verification module 910 may be further configured to determine whether a user associated with the user device is driving, the determination based on a trip booking associated with the user, and request a verification from another user device whether a determined weather condition for the location is correct, the another user device being a requestor of the trip booking. In an implementation, the verification module 910 may be further configured to, in response to a verification from the user device, identify one or more other user devices within a proximity from the user device, and request a further verification from each of the one or more other user devices whether a further determined weather condition for each of the one or more other user devices is correct.

With reference to FIGS. 1 to 7, the weather module 912 performs the function of detecting the weather condition of the location based on the determination (e.g., by the determination module 908). In an implementation, the weather module 910 may be configured to confirm the weather condition of the location based on a verification from the user device or another user device, the another user device being a requestor of a trip booking associated with the user device. In an implementation, the weather module 910 may be configured to further confirm the weather condition of the location based on a further verification from each of one or more other user devices. In an implementation, the weather module 912 may be further configured to determine an area around the location with the determined weather condition based on the verification from the user device and the further verification from the one or more other user devices. In an implementation, the weather module 912 may be further configured to determine an intensity of the determined weather condition based on the verification and the further verification. In an implementation, the weather module 912 may be further configured to recommend a route to the user based on the determination whether the audio recording corresponds to the indication that the location is sheltered. In an implementation, the weather module 912 may be further configured to aggregate data relating to a plurality of previous detections of weather conditions of the location, and detect the weather condition of the location further based on the aggregated data.

With reference to FIGS. 1 to 7, the data module 906 performs the functions of receive data and information from the requestor device 102, provider device 104, transaction processing server 108, reference database 150, a cloud and other sources of information to detect a weather condition of a location by the weather server 140. For example, the data module 906 may be configured to receive data and information required for determining whether an audio recording of a location corresponds to a weather condition and detecting the weather condition of the location based on the determination, determining whether a user associated with a user device is driving, identifying one or more other user devices within a proximity from a user device, confirming a weather condition based on one or more verifications, determining an area around a location with a determined weather condition, filtering noise from an audio recording, determining whether a location is sheltered, and other similar processes from the requestor device 102, the provider device 104, transaction processing server 108, reference database 150, and/or other sources of information. The data module 906 may be further configured to send information relating to data retrieved in response to a trip booking request to the requestor device 102, the provider device 104, the transaction processing server 108, or other destinations where the information is required.

FIG. 8B depicts a general-purpose computer system 1500, upon which a combined transaction processing server 108 and weather server 140 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 8D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple or like computer systems.

The steps of the method 700 performed by the weather server 140 and facilitated by the transaction processing server 108 may be implemented using the computer system 1500. For example, the steps of the method 700 as performed by the weather server 140 may be implemented as one or more software application programs 1533 executable within the computer system 1500. In particular, the steps of the method 700 are effected by instructions in the software 1533 that are carried out within the computer system 1500. The software instructions may be formed as one or more code modules, each for performing one or more particular tasks. The software may also be divided into two separate parts, in which a first part and the corresponding code modules performs the steps of the method 700 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined transaction processing and weather server.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined transaction processing and weather server.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (e.g., combined transaction processing and weather server 1500) is presented merely by way of example. Therefore, in some arrangements, one or more features of the server 1500 may be omitted. Also, in some arrangements, one or more features of the server 1500 may be combined together. Additionally, in some arrangements, one or more features of the server 1500 may be split into one or more component parts.

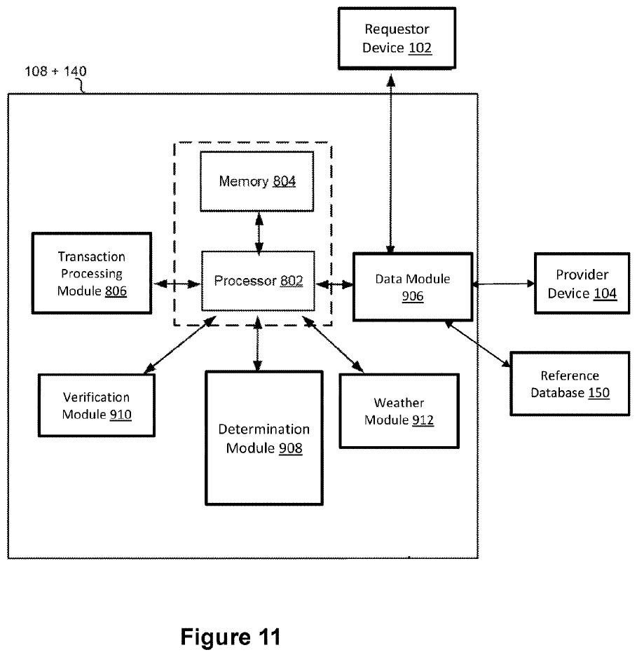

FIG. 11 shows an alternative implementation of combined transaction processing and weather server (i.e., the computer system 1500). In the alternative implementation, the combined transaction processing and weather server may be generally described as a physical device comprising at least one processor 1002 and at least one memory 904 including computer program codes. The at least one memory 1004 and the computer program codes are configured to, with the at least one processor 1002, cause the combined transaction processing and weather server to perform the operations described in the steps of the method 700. The combined transaction processing and weather server may also include a transaction processing module 806, a data module 906, a determination module 908, a verification module 910 and a weather module 912. The memory 1004 stores computer program code that the processor 1002 compiles to have each of the modules 806 to 912 performs their respective functions. The transaction processing module 806 performs the same functions as described for the same transaction processing module in FIG. 9. The data module 906, determination module 908, verification module 910 and weather module 912 perform the same functions as described for the same corresponding modules in FIG. 10.

It will be appreciated by a person skilled in the art that numerous variations and/or modifications may be made to the present disclosure as shown in the specific embodiments without departing from the scope of the specification as broadly described. The present embodiments are, therefore, to be considered in all respects to be illustrative and not restrictive.

1. A method for detecting a weather condition of a location, comprising:
determining, by a processor, whether an audio recording of the location from a user device at the location corresponds to the weather condition, the determination being based on historical data indicating at least one corresponding sound for the weather condition; and
detecting, by the processor, the weather condition of the location based on the determination.

2. The method of claim 1, wherein determining whether the audio recording of the location from the user device at the location corresponds to the weather condition further comprises:
determining, for each of one or more segments of the audio recording, whether each segment corresponds to the weather condition based on the historical data, the determination being made in real time as the user device is recording each segment at the location;
filtering a determination result for each of the one or more segments based on a threshold; and
determining the weather condition of the location based on the filtered determination result.

3. The method of claim 1, wherein detecting the weather condition of the location further comprises:
requesting a verification from the user device whether a determined weather condition for the location is correct; and
confirming the weather condition of the location based on the verification.

4. The method of claim 1, wherein detecting the weather condition of the location further comprises:
determining whether a user associated with the user device is driving, the determination being based on a trip booking associated with the user;
requesting a verification from another user device whether a determined weather condition for the location is correct, the another user device being a requestor of the trip booking; and
confirming the weather condition of the location based on the verification.

5. The method of claim 3, further comprising:
in response to the verification, identifying one or more other user devices within a proximity from the user device;
further determining whether an audio recording from each of the one or more other user devices corresponds to a weather condition;
requesting a further verification from each of the one or more other user devices whether a further determined weather condition for each of the one or more other user devices is correct; and
further confirming the weather condition of the location based on the further verification from each of the one or more other user devices.

6. The method of claim 5, further comprising determining an area around the location with the determined weather condition based on the verification and the further verification.

7. The method of claim further comprising determining an intensity of the determined weather condition based on the verification and the further verification.

8. The method of claim 1, wherein determining whether the audio recording of the location from the user device at the location corresponds to the weather condition further comprises filtering noise from the audio recording based on the location as well as a vehicle and an activity associated with the user device, the filtering being based on the historical data further indicating at least one sound associated with each of the location, the vehicle and the activity.

9. The method of claim 1, further comprising determining whether the audio recording corresponds to an indication that the location is sheltered, the determination being based on the historical data further indicating at least one sound associated with a sheltered area; and detecting whether the location is sheltered based on the determination whether the audio recording corresponds to the indication that the location is sheltered.

10. The method of claim 9, further comprising recommending a route to the user based on the determination whether the audio recording corresponds to the indication that the location is sheltered.

11. The method of claim 1, further comprising aggregating data relating to a plurality of previous detections of weather conditions of the location, and detecting the weather condition of the location further based on the aggregated data.

12. A system for detecting a weather condition of a location, comprising:
at least one processor; and
at least one memory including computer program code;
wherein the at least one processor is configured to execute the program code to cause the system to:
determine whether an audio recording of the location from a user device at the location corresponds to the weather condition, the determination being based on historical data indicating at least one corresponding sound for the weather condition; and
detect the weather condition of the location based on the determination.

13. The system of claim 12, wherein determining whether the audio recording of the location from the user device at the location corresponds to the weather condition further comprises:
determining, for each of one or more segments of the audio recording, whether each segment corresponds to the weather condition based on the historical data, the determination being made in real time as the user device is recording each segment at the location;
filtering a determination result for each of the one or more segments based on a threshold; and
determining the weather condition of the location based on the filtered determination result.

14. The system of claim 12, wherein detecting the weather condition of the location further comprises:
requesting a verification from the user device whether a determined weather condition for the location is correct; and
confirming the weather condition of the location based on the verification.

15. The system of claim 12, wherein detecting the weather condition of the location further comprises:
determining whether a user associated with the user device is driving, the determination being based on a trip booking associated with the user;
requesting a verification from another user device whether a determined weather condition for the location is correct, the another user device being a requestor of the trip booking; and
confirming the weather condition of the location based on the verification.

16. The system of claim 14, further configured to:
in response to the verification, identify one or more other user devices within a proximity from the user device;
further determine whether an audio recording from each of the one or more other user devices corresponds to a weather condition;
request a further verification from each of the one or more other user devices whether a further determined weather condition for each of the one or more other user devices is correct; and
further confirm the weather condition of the location based on the further verification from each of the one or more other user devices.

17. The system of claim 16, further configured to determine an area around the location with the determined weather condition based on the verification and the further verification.

18. The system of claim 16, further comprising determining an intensity of the determined weather condition based on the verification and the further verification.

19. The system of claim 12, wherein determining whether the audio recording of the location from the user device at the location corresponds to the weather condition further comprises filtering noise from the audio recording based on the location as well as a vehicle and an activity associated with the user device, the filtering being based on the historical data further indicating at least one sound associated with each of the location, the vehicle and the activity.

20. The system of claim 12, further configured to determine whether the audio recording corresponds to an indication that the location is sheltered, the determination being based on the historical data further indicating at least one sound associated with a sheltered area; and detect whether the location is sheltered based on the determination whether the audio recording corresponds to the indication that the location is sheltered.

21. (canceled)

22. (canceled)
